(19) United States
(12) Patent Application Publication
(10) Pub. No.: US 2021/0259164 A1
(43) Pub. Date: Aug. 26, 2021

(54) Bottomless Plant Watering Assembly

(71) Applicant: Carie Centeno, Shadow Hills, CA (US)

(72) Inventor: Carie Centeno, Shadow Hills, CA (US)

(21) Appl. No.: 16/796,317

(22) Filed: Feb. 20, 2020

(51) Int. Cl. A01G 9/28; A01G 9/02

(52) U.S. Cl. CPC A01G 9/28; A01G 2009/003; A01G 9/02

(57) ABSTRACT

A bottomless plant watering assembly for retaining water around a plant growing outdoors includes a plurality of panels and each of the panels is bendable into a semi-circular shape. The plurality of panels is releasably attachable together when each of the panels is bent into the semi-circular shape such that the plurality of panels defines a ring. The ring can be sunk into ground thereby facilitating the ring to surround a plant growing in the ground. A plurality of pins is provided and each of the pins is coupled to a respective one of the panels. Each of the pins releasably engages the engagement point on an adjacent one of the panels when the panels are bent thereby releasably attaching the plurality of panels together.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to plant watering devices and more particularly pertains to a new plant watering device for retaining water around a plant growing outdoors.

### (2) Description of Related Art Including Information Disclosed Under 37 CFR 1.97 and 1.98

The prior art relates to plant watering devices. The prior art discloses a plurality of panels, each having a plurality of fasteners thereon, that are removably attachable together to form a ring for surrounding a plant. The prior art discloses a plant pot that has a removable bottom to facilitate the plant pot to be sunk into ground around a plant. The prior art discloses a cylinder that has double wall construction for being sunk into ground around a plant. The prior art discloses a panel that is bendable over itself to form a cylinder that can be sunk into ground to surround a plant. Additionally, the prior art discloses a plant container that includes a porous portion and a non-porous portion.

### BRIEF SUMMARY OF THE INVENTION

An embodiment of the disclosure meets the needs presented above by generally comprising a plurality of panels and each of the panels is bendable into a semi-circular shape. The plurality of panels is releasably attachable together when each of the panels is bent into the semi-circular shape such that the plurality of panels defines a ring. The ring can be sunk into ground thereby facilitating the ring to surround a plant growing in the ground. In this way water is retained around the plant to enhance the health of the plant. A plurality of pins is provided and each of the pins is coupled to a respective one of the panels. Each of the pins releasably engages the engagement point on an adjacent one of the panels when the panels are bent thereby releasably attaching the plurality of panels together.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a bottomless plant watering assembly according to an embodiment of the disclosure.

FIG. 2 is a back view of an embodiment of the disclosure.

FIG. 3 is a front view of an embodiment of the disclosure.

FIG. 4 is a right side view of an embodiment of the disclosure.

FIG. 5 is a back perspective in-use view of an embodiment of the disclosure showing a pair of panels being coupled together.

FIG. 6 is a cross sectional view taken along line 6-6 of FIG. 5 of an embodiment of the disclosure.

FIG. 7 is a top perspective view of an embodiment of the disclosure showing a pair of panels being coupled together and formed into a ring.

FIG. 8 is a perspective in-use view of an embodiment of the disclosure.

### DETAILED DESCRIPTION OF THE INVENTION

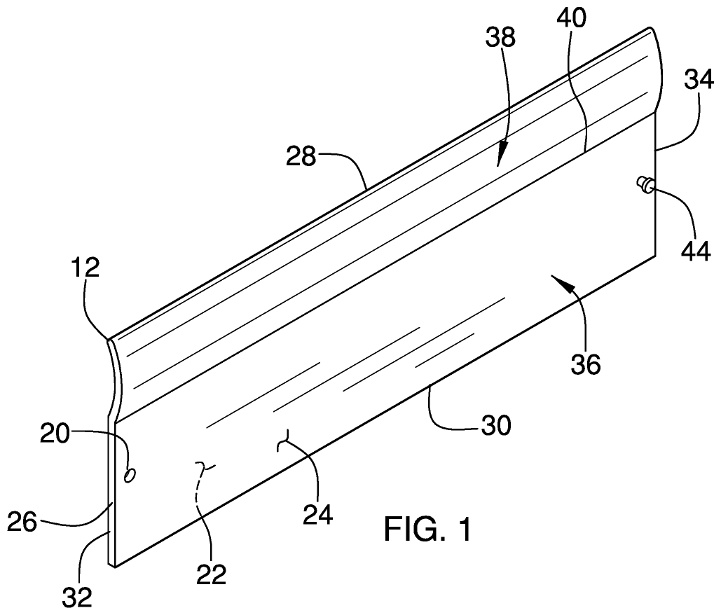

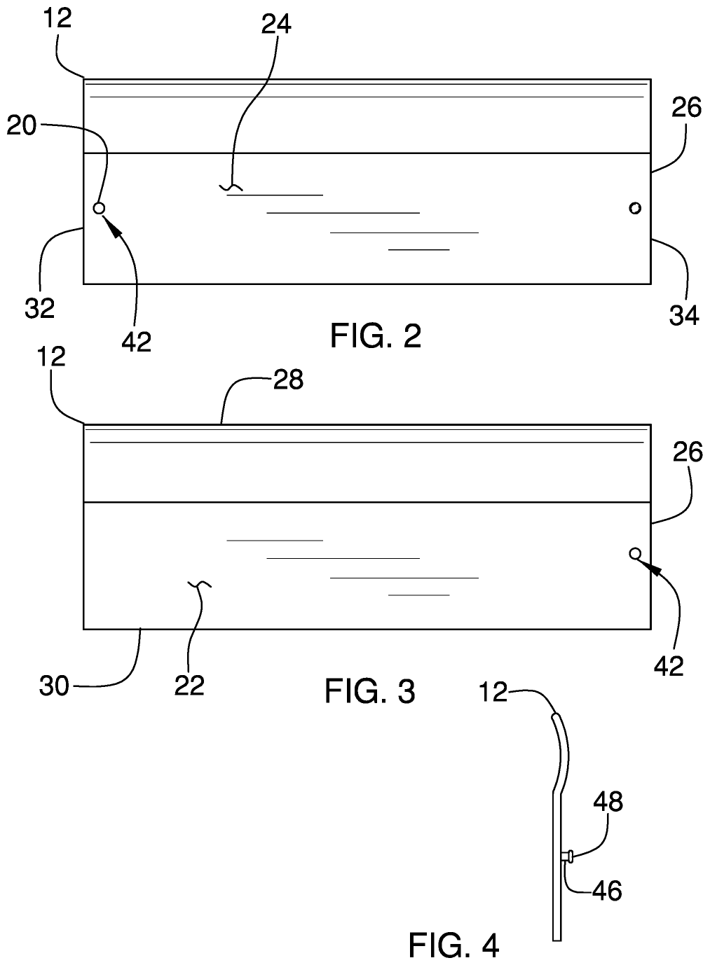

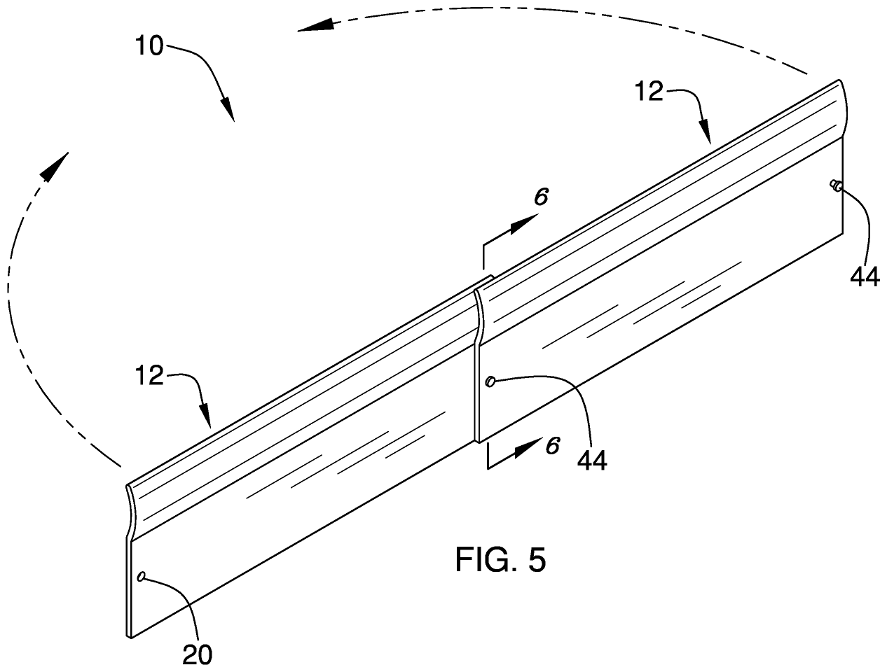

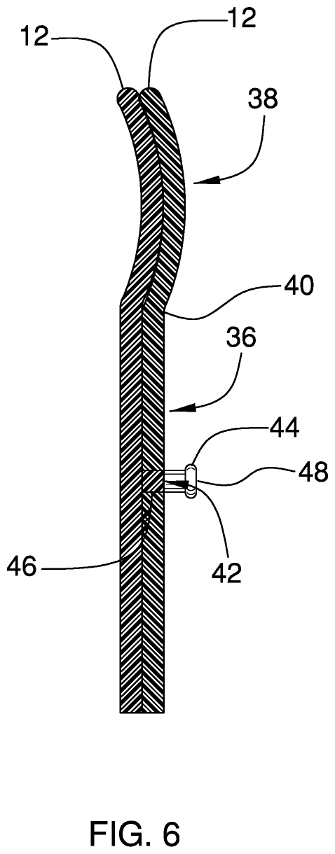

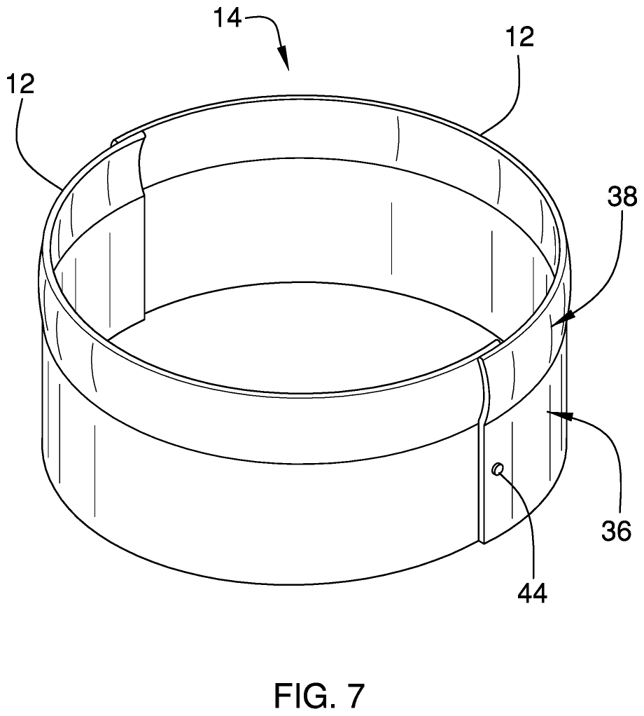

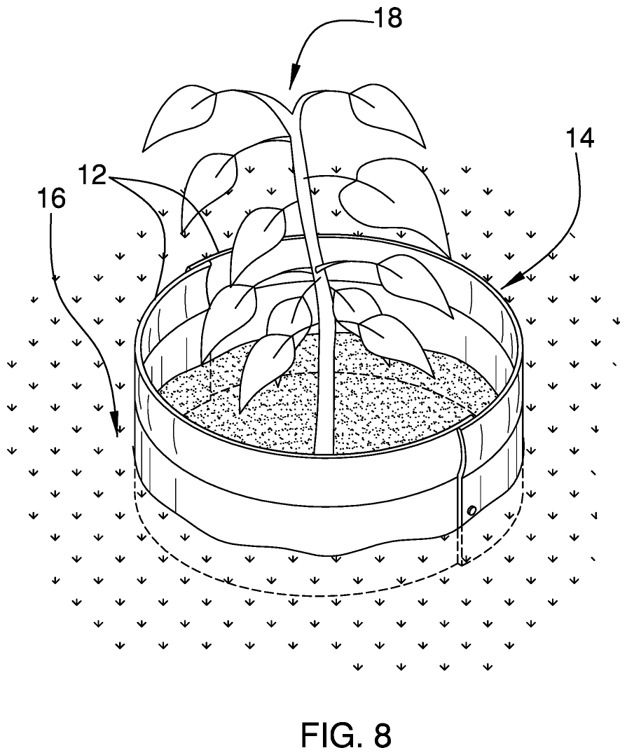

With reference now to the drawings, and in particular to FIGS. 1 through 8 thereof, a new plant watering device embodying the principles and concepts of an embodiment of the disclosure and generally designated by the reference numeral 10 will be described.

As best illustrated in FIGS. 1 through 8, the bottomless plant watering assembly 10 generally comprises a plurality of panels 12 that is each longitudinally elongated. Each of the panels 12 is comprised of a flexible material and each of the panels 12 is bendable into a semi-circular shape. The plurality of panels 12 is releasably attachable together when each of the panels 12 is bent into the semi-circular shape. In this way the plurality of panels 12 define a ring 14 to be sunk into ground 16 thereby facilitating the ring 14 to surround a plant 18 growing in the ground 16. Additionally, each of the panels 12 has an engagement point 20 thereon. Each of the panels 12 is comprised of a fluid impermeable material to inhibit water from soaking away from the plant 18 around which the ring 14 is positioned.

Each of the panels 12 has a front surface 22, a back surface 24 and a perimeter edge 26 extending therebetween, and the perimeter edge 26 has a top side 28, a bottom side 30, a first lateral side 32 and a second lateral side 34. Each of the panels 12 is elongated between the first lateral side 32 and the second lateral side 34. Additionally, each of the panels 12 has a planar portion 36 and a curved portion 38 each extending between the first lateral side 32 and the second lateral side 34. The curved portion 38 extends between the top side 28 and a threshold 40 between the curved portion 38 and the planar portion 36 and the curved portion 38 is concavely arcuate with respect to the front surface 22.

The bottom side 30 of the perimeter edge 26 of each of the panels 12 is urgeable downwardly into the ground 16 when the panels 12 are attached together to form the ring 14. Moreover, the curved portion 38 of each of the panels 12 is exposed when the ring 14 is urged into the ground 16. Each of the panels 12 has a hole 42 extending through the front surface 22 and the back surface 24 to define the engagement point 20. The hole 42 is positioned on the planar portion 36 and the hole 42 is positioned adjacent to the first lateral side 32.

A plurality of pins 44 is provided and each of the pins 44 is coupled to a respective one of the panels 12. Each of the pins 44 releasably engages the engagement point 20 on an adjacent one of the panels 12 when the panels 12 are bent thereby releasably attaching the plurality of panels 12 together. Each of the pins 44 has a stem 46 and a head 48, and the stem 46 extends along a line oriented perpendicular to the back surface 24 corresponding to the planar portion 36 of the respective panel. The head 48 of each of the pins 44 is spaced from the back surface 24 of the respective panel and the head 48 on each of the pins 44 is comprised of a resiliently compressible material.

The head 48 on each of the pins 44 has a diameter that is greater than the diameter of the hole 42. In this way the pins 44 are inhibited from being removed from the hole 42. Each of the pins 44 is positioned on the back surface 24 corresponding to the planar portion 36 of the respective panel. Additionally, each of the pins 44 is positioned adjacent to the second lateral side 34 of the perimeter edge 26 of the respective panel. Moreover, each of the pins 44 is positioned on a horizontal line extending through the hole 42 and the pin 44 in the respective panel 12.

In use, each of the panels 12 is bent into the semi-circular shape and the pin 44 on each of the panels 12 is extended through the hole 42 in an adjacent panel. In this way the plurality of panels 12 is formed into a ring 14. The ring 14 is urged downwardly into the ground 16 to surround a plant 18 that is growing in the ground 16. Additionally, the ring 14 does not inhibit growth of the roots of the plant 18 in the way that a traditional plant pot inhibits root growth. In this way the plant 18 is afforded the greatest possible level of protection without being limited from a growth perspective. Moreover, the ring 14 inhibits water from soaking away from the plant 18 when the plant 18 is watered to further enhance the health of the plant 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bottomless plant watering assembly being insertable into ground for surrounding a plant that is growing in the ground, said assembly comprising:
a plurality of panels, each of said panels being longitudinally elongated, each of said panels being comprised of a flexible material, each of said panels being bendable into a semi-circular shape, said plurality of panels being releasably attachable together when each of said panels is bent into said semi-circular shape such that said plurality of panels defines a ring wherein said ring is configured to be sank into ground thereby facilitating said ring to surround a plant growing in the ground, each of said panels having an engagement point thereon; and
a plurality of pins, each of said pins being coupled to a respective one of said panels, each of said pins releasably engaging said engagement point on an adjacent one of said panels when said panels are bent thereby releasably attaching said plurality of panels together.

2. The assembly according to claim 1, wherein each of said panels has a front surface, a back surface and a perimeter edge extending therebetween, said perimeter edge having a top side, a bottom side, a first lateral side and a second lateral side, each of said panels being elongated between said first lateral side and said second lateral side, each of said panels having a planar portion and a curved portion each extending between said first lateral side and said second lateral side.

3. The assembly according to claim 2, wherein said curved portion extends between said top side and a threshold between said curved portion and said planar portion, said curved portion being concavely arcuate with respect to said front surface, said bottom side of said perimeter edge of each of said panels being urgeable downwardly into the ground when said panels are attached together to form said ring having said curved portion of each of said panels being exposed.

4. The assembly according to claim 2, wherein each of said panels has a hole extending through said front surface and said back surface to define said engagement point, said hole being positioned on said planar portion, said hole being positioned adjacent to said first lateral side.

5. The assembly according to claim 4, wherein each of said pins has a stem and a head, said stem extending along a line being oriented perpendicular to said back surface corresponding to said planar portion of said respective panel, said head of each of said pins being spaced from said back surface of said respective panel, said head on each of said pins being comprised of a resiliently compressible material, said head on each of said pins having a diameter being greater than the diameter of said hole thereby inhibiting said pins from being removed from said hole.

6. The assembly according to claim 4, wherein each of said pins is positioned on said back surface corresponding to said planar portion of said respective panel, each of said pins being positioned adjacent to said second lateral side of said perimeter edge of said respective panel, each of said pins being positioned on a horizontal line extending through said hole and said pin in said respective panel.

7. A bottomless plant watering assembly being insertable into ground for surrounding a plant that is growing in the ground, said assembly comprising:
a plurality of panels, each of said panels being longitudinally elongated, each of said panels being comprised of a flexible material, each of said panels being bendable into a semi-circular shape, said plurality of panels being releasably attachable together when each of said panels is bent into said semi-circular shape such that said plurality of panels defines a ring wherein said ring is configured to be sank into ground thereby facilitating said ring to surround a plant growing in the ground, each of said panels having an engagement point thereon, each of said panels being comprised of a fluid impermeable material wherein said plurality of panels is configured to inhibit water from passing therethrough, each of said panels having a front surface, a back surface and a perimeter edge extending therebetween, said perimeter edge having a top side, a bottom side, a first lateral side and a second lateral side, each of said panels being elongated between said first lateral side and said second lateral side, each of said panels having a planar portion and a curved portion each extending between said first lateral side and said second lateral side, said curved portion extending between said top side and a threshold between said curved portion and said planar portion, said curved portion being concavely arcuate with respect to said front surface, said bottom side of said perimeter edge of each of said panels being urgeable downwardly into the ground when said panels are attached together to form said ring having said curved portion of each of said panels being exposed, each of said panels having a hole extending through said front surface and said back surface to define said engagement point, said hole being positioned on said planar portion, said hole being positioned adjacent to said first lateral side; and
a plurality of pins, each of said pins being coupled to a respective one of said panels, each of said pins releasably engaging said engagement point on an adjacent one of said panels when said panels are bent thereby releasably attaching said plurality of panels together, each of said pins having a stem and a head, said stem extending along a line being oriented perpendicular to said back surface corresponding to said planar portion of said respective panel, said head of each of said pins being spaced from said back surface of said respective panel, said head on each of said pins being comprised of a resiliently compressible material, said head on each of said pins having a diameter being greater than the diameter of said hole thereby inhibiting said pins from being removed from said hole, each of said pins being positioned on said back surface corresponding to said planar portion of said respective panel, each of said pins being positioned adjacent to said second lateral side of said perimeter edge of said respective panel, each of said pins being positioned on a horizontal line extending through said hole and said pin in said respective panel.
